(19) United States
(12) Patent Application Publication
(10) Pub. No.: US 2015/0300614 A1
(43) Pub. Date: Oct. 22, 2015

(54) Optical Communication Module

(71) Applicant: Hitachi Metals, Ltd., Tokyo (JP)

(72) Inventors: Kenichi TAMURA, Hitachi (JP); Ryuta TAKAHASHI, Hitachi (JP); Yoshinori SUNAGA, Hitachinaka (JP)

(21) Appl. No.: 14/340,885

(22) Filed: Jul. 25, 2014

(30) Foreign Application Priority Data
Apr. 17, 2014 (JP) 2014-085359

(51) Int. Cl. F21V 23/00

(52) U.S. Cl. CPC F21V 23/005

(57) ABSTRACT

An optical communication module includes: a plurality of semiconductor lasers which emit optical signals each having different wavelengths; a plurality of driver ICs which drive each of the plurality of semiconductor lasers; and a substrate on which both of the semiconductor lasers and the driver ICs are mounted. The semiconductor lasers are mounted on a first surface of the substrate and the driver ICs are mounted on a second surface of the substrate opposite to the first surface.

### CROSS-REFERENCE TO RELATED APPLICATION

The present application claims priority from Japanese Patent Application No. 2014-085359 filed on Apr. 17, 2014, the content of which is hereby incorporated by reference into this application.

### TECHNICAL FIELD OF THE INVENTION

The present invention relates to an optical communication module, in particular, to an optical communication module used for the wavelength division multiplexing (WDM) communication.

### BACKGROUND OF THE INVENTION

Various types of WDM optical communication modules have been developed, and a WDM optical transceiver is one of them. For example, a WDM optical transceiver provided with a transmitter optical sub-assembly (TOSA) which multiplexes a plurality of optical signals emitted from a plurality of light sources and having different wavelengths has been developed and put into practical use.

A conventional transmitter optical sub-assembly has a plurality of light emitting elements which output optical signals each having different wavelengths and a plurality of driving elements which drive these light emitting elements. The plurality of light emitting elements are mounted on a first substrate and the plurality of driving elements are mounted on a second substrate different from the first substrate, and the first substrate and the second substrate are connected through a flexible wiring board or the like (Japanese Patent Application Laid-Open Publication No. 2008-203427 (Patent Document 1)).

### SUMMARY OF THE INVENTION

In recent years, the communication speed of WDM optical communication modules including an optical transceiver has been increasing. At present, the communication speed of a WDM optical communication module is about 10 to 40 Gbit/sec, and it is expected that the communication speed is increased to about 100 Gbit/sec in the future.

Here, the high-speed digital signals have large loss in electrical transmission. Therefore, in order to increase the communication speed of the WDM optical communication module, the transmission distance (electrical transmission distance) of the digital signals inside the module needs to be as short as possible.

However, if the light emitting elements and the driving elements are mounted on separate substrates like the transmitter optical sub-assembly described in the Patent Document 1, the transmission distance between the light emitting element and the driving element is increased. As a result, there is a threat that the loss of digital signals between the light emitting element and the driving element becomes too large to ignore with the increase of communication speed.

An object of the present invention is to shorten the transmission distance of digital signals between a light emitting element and a driving element inside an optical communication module.

An optical communication module of the present invention is an optical communication module which outputs multiplexed optical signals. This optical communication module includes: a plurality of light emitting elements which emit optical signals each having different wavelengths; a plurality of driving elements which drive each of the plurality of light emitting elements; and a substrate on which both of the light emitting elements and the driving elements are mounted. In this optical communication module, the light emitting elements are mounted on a first surface of the substrate. Also, the driving elements are mounted on a second surface of the substrate opposite to the first surface.

In one aspect of the present invention, the substrate is housed in a chassis. Also, a surface of the driving element and a first inner surface of the chassis are thermally connected through a heat conducting member.

In another aspect of the present invention, the plurality of light emitting elements are disposed in a row along a longitudinal direction of the chassis, and each of the light emitting elements emits an optical signal to a second inner surface of the chassis opposed to the first inner surface.

In another aspect of the present invention, the plurality of light emitting elements are surface-mounted on the first surface of the substrate, and the respective driving elements are mounted at positions opposed to the light emitting elements serving as objects to be driven with the substrate interposed therebetween.

According to the present invention, it is possible to shorten the transmission distance of digital signals between a light emitting element and a driving element inside an optical communication module.

### BRIEF DESCRIPTIONS OF THE DRAWINGS

FIG. 1 is a perspective view of an optical transceiver to which the present invention is applied;

FIG. 2 is a sectional view taken along the line A-A in FIG. 1 and schematically shows a general structure of a transmitter optical assembly;

FIG. 3 is a partially enlarged view of FIG. 2;

FIG. 4 is a sectional view schematically showing an arrangement of a substrate, semiconductor lasers and driver ICs inside a chassis; and

FIG. 5 is an enlarged view showing another mounting method of semiconductor lasers.

### DESCRIPTIONS OF THE PREFERRED EMBODIMENTS

Hereinafter, an example of an optical communication module to which the present invention is applied will be described in detail with reference to accompanying drawings. The optical communication module described below is a WDM optical transceiver compliant with QSFP+ (Quad Small Form-factor Pluggable Plus) standard, and it outputs multiplexed optical signals obtained by multiplexing a plurality of optical signals having different wavelengths.

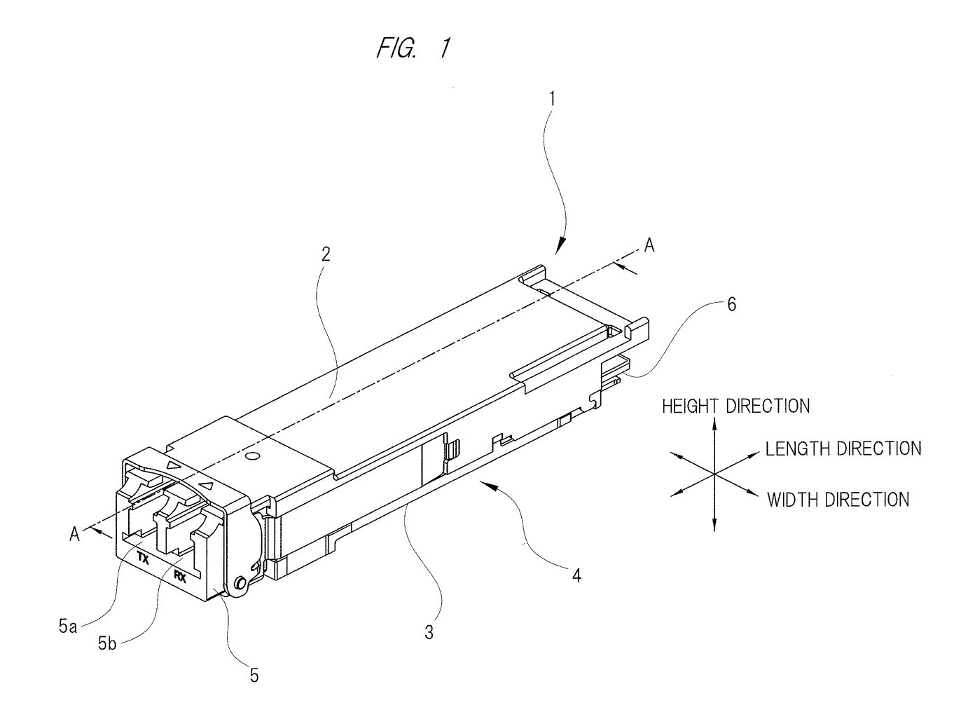

As shown in FIG. 1, an optical transceiver 1 of this embodiment has a chassis 4 made up of an upper case 2 and a lower case 3. The chassis 4 has a substantially cuboid external appearance as a whole, and has a size compliant with the QSFP+ standard. An optical adaptor 5 is provided at one longitudinal end of the chassis 4, and a card edge 6 is provided at the other longitudinal end of the chassis 4. Note that the card edge is sometimes referred to as “edge connector”. In the following description, of the both longitudinal ends of the chassis 4, one end side on which the optical adaptor 5 is provided is referred to as “front side” and the other end side on which the card edge 6 is provided is referred to as “rear side” in some cases. More specifically, the optical adaptor 5 is provided on the front side of the chassis 4 and the card edge 6 is provided on the rear side of the chassis 4.

The optical adaptor 5 has two insertion ports 5a and 5b to which an optical connector attached to one end of an optical fiber cable (not shown) is inserted. One insertion port 5a is a transmitter port (Tλ) and the other insertion port 5b is a receiver port (Rλ). Also, when the card edge 6 is inserted into a slot provided in a network device (router, server or others (not shown)), the optical transceiver 1 and the network device are connected. The optical transceiver 1 converts an electric signal input from the connected network device into an optical signal and outputs it to an optical fiber cable connected to the transmitter insertion port 5a, and it also converts an optical signal input from an optical fiber cable connected to the receiver insertion port 5b into an electric signal and outputs it to a network device.

Inside the chassis 4, a transmitter optical sub-assembly (TOSA) and a receiver optical sub-assembly (ROSA) for achieving the above-described photoelectric conversion are housed.

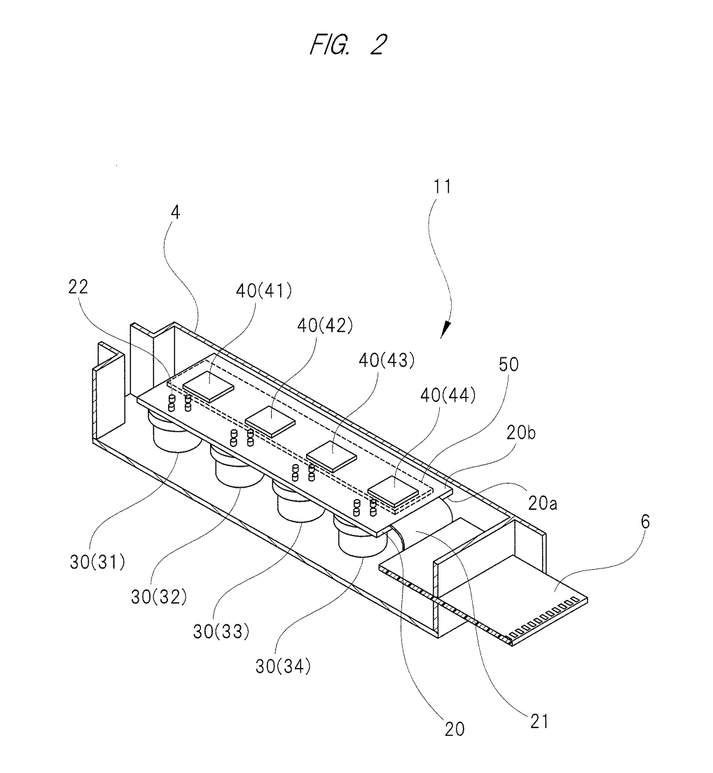

FIG. 2 is a schematic sectional view taken along the line A-A in FIG. 1, and it shows a general structure of a transmitter optical sub-assembly 11 housed in the chassis 4. The transmitter optical sub-assembly 11 has a substrate 20 housed in the chassis 4, semiconductor lasers 30 serving as light emitting elements mounted on the substrate 20 and driver ICs 40 serving as driving elements. They will be concretely described below.

The substrate 20 is a rigid substrate with a substantially rectangular shape when seen in a plan view, and is electrically connected to the card edge 6 through a flexible wiring board 21. A first semiconductor laser 31, a second semiconductor laser 32, a third semiconductor laser 33 and a fourth semiconductor laser 34 each having different oscillation wavelengths are mounted on one surface (first surface 20a) of the substrate 20. On the other hand, a first driver IC 41, a second driver IC 42, a third driver IC 43 and a fourth driver IC 44 are mounted on the other surface (second surface 20b) of the substrate 20 opposite to the first surface 20a. In the following description, the first semiconductor laser 31, the second semiconductor laser 32, the third semiconductor laser 33 and the fourth semiconductor laser 34 are collectively referred to as “semiconductor laser 30” in some cases. Also, the first driver IC 41, the second driver IC 42, the third driver IC 43 and the fourth driver IC 44 are collectively referred to as “driver IC 40” in some cases.

Each of the semiconductor lasers 30 has a laser diode, a lens for condensing a laser light serving as an optical signal emitted from the laser diode, and a metal package which houses and integrates the laser diode and the lens. More specifically, each of the semiconductor lasers 30 is a TO-CAN package.

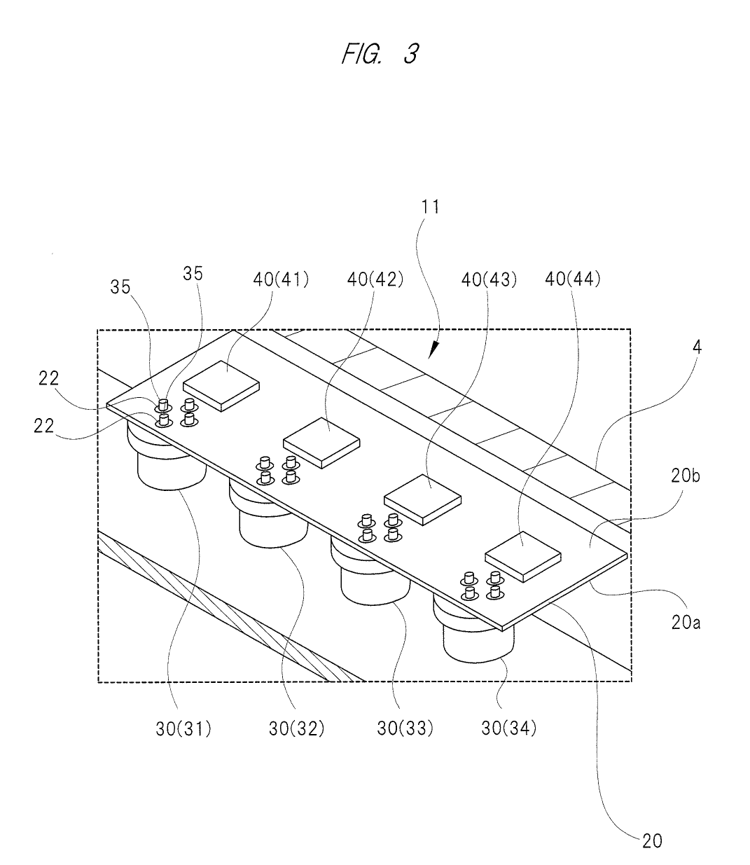

As shown in FIG. 3, the first semiconductor laser 31, the second semiconductor laser 32, the third semiconductor laser 33 and the fourth semiconductor laser 34 are disposed in this order in a row along a longitudinal direction of the substrate 20. Here, the longitudinal direction of the substrate 20 coincides with a longitudinal direction of the chassis 4. More specifically, the first semiconductor laser 31, the second semiconductor laser 32, the third semiconductor laser 33 and the fourth semiconductor laser 34 are disposed in this order in a row along the longitudinal direction of the chassis 4.

The oscillation wavelength of the first semiconductor laser 31 is λ1 [nm], the oscillation wavelength of the second semiconductor laser 32 is λ2 [nm], the oscillation wavelength of the third semiconductor laser 33 is λ3 [nm] and the oscillation wavelength of the fourth semiconductor laser 34 is λ4 [nm]. These oscillation wavelengths have the magnitude relation of λ1<λ2<λ3<λ4. More specifically, respective semiconductor lasers 30 emit optical signals each having different wavelengths. Concretely, the first semiconductor laser 31 emits an optical signal having a wavelength of λ1 [nm], the second semiconductor laser 32 emits an optical signal having a wavelength of λ2 [nm], the third semiconductor laser 33 emits an optical signal having a wavelength of λ3 [nm] and the fourth semiconductor laser 34 emits an optical signal having a wavelength of λ4 [nm]. In the following description, the optical signal emitted from the first semiconductor laser 31 is referred to as “first optical signal”. Also, the optical signal emitted from the second semiconductor laser 32 is referred to as “second optical signal”, the optical signal emitted from the third semiconductor laser 33 is referred to as “third optical signal” and the optical signal emitted from the fourth semiconductor laser 34 is referred to as “fourth optical signal”.

The first driver IC 41, the second driver IC 42, the third driver IC 43 and the fourth driver IC 44 are disposed in this order in a row along the longitudinal direction of the substrate 20 (chassis 4) in the same manner as the semiconductor lasers 30.

An object to be driven by the first driver IC 41 is the first semiconductor laser 31, an object to be driven by the second driver IC 42 is the second semiconductor laser 32, an object to be driven by the third driver IC 43 is the third semiconductor laser 33 and an object to be driven by the fourth driver IC 44 is the fourth semiconductor laser 34.

The semiconductor laser 30 and the driver IC corresponding to each other are electrically connected through a through hole and a wiring layer formed in the substrate 20. Concretely, each of the semiconductor lasers 30 has four lead pins 35. On the other hand, the substrate 20 has through hole groups corresponding to each semiconductor laser 30. Each of the through hole groups includes four through holes 22. Each through hole 22 penetrates the substrate 20, and the four lead pins 35 protruding from the semiconductor laser 30 mounted on the first surface 20a of the substrate 20 are inserted into the four through holes 22 included in the corresponding through hole group. End portions of the lead pins 35 inserted into the through holes 22 penetrate the substrate 20 and slightly protrude from the second surface 20b of the substrate 20. More specifically, the semiconductor laser 30 in the present embodiment is through-hole mounted on the substrate 20. Note that, of the four lead pins 35, one is for anode, another is for cathode, another is for monitor and the other is for ground. Of course, the lead pin for anode or the lead pin for cathode doubles as a lead pin for ground in some cases. Also, the lead pin for monitor is sometimes omitted.

The driver IC 40 connected to the semiconductor laser 30 in the above-described manner outputs an electric signal (driving signal) to the semiconductor laser 30 serving as an object to be driven, thereby driving the semiconductor laser 30.

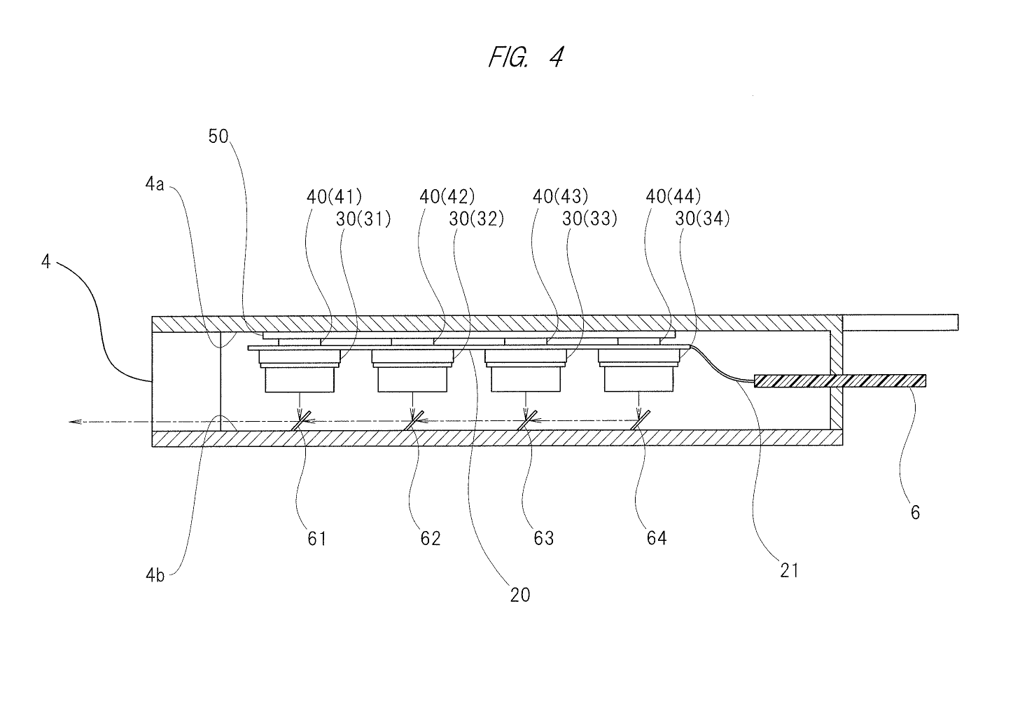

As shown in FIG. 4, the chassis 4 has a first inner surface 4a and a second inner surface 4b opposed to each other. These inner surface 4a and second inner surface 4b extend along the longitudinal direction of the chassis 4. Thus, in the following description, the opposed direction between the first inner surface 4a and the second inner surface 4b is defined as “height direction” of the optical transceiver 1, the extending direction of the first inner surface 4a and the second inner surface 4b (longitudinal direction of chassis 4) is defined as “length direction” of the optical transceiver 1, and the direction orthogonal to the height direction and the length direction is defined as “width direction” of the optical transceiver 1. For easy understanding, arrows indicating the three directions are shown in FIG. 1. Also, in the following description, the first inner surface 4a of the chassis 4 is referred to as “ceiling surface 4a” and the second inner surface 4b is referred to as “bottom surface 4b”.

As shown in FIG. 4, the substrate 20 is housed in the chassis 4 so that a surface (upper surface) of the driver IC 40 is opposed to the ceiling surface 4a of the chassis 4 and an emission end surface of the semiconductor laser 30 is opposed to the bottom surface 4b of the chassis 4. Also, a heat conducting member (heat dissipation sheet 50 in this embodiment) is interposed between the surface (upper surface) of the driver IC 40 and the ceiling surface 4a of the chassis 4 opposed to each other. In other words, the driver IC 40 and the chassis 4 are thermally connected through the heat dissipation sheet 50 serving as a heat conducting member.

On the other hand, the semiconductor laser 30 emits the optical signal to the bottom surface 4b of the chassis 4. More specifically, the emission direction of the semiconductor laser 30 coincides with the height direction of the optical transceiver 1 shown in FIG. 1.

With reference to FIG. 4 again, wavelength selective filters and a reflection mirror for multiplexing the optical signals emitted from the semiconductor lasers 30 are disposed between the semiconductor lasers 30 and the bottom surface 4b of the chassis 4. Concretely, a first wavelength selective filter 61 is disposed between the first semiconductor laser 31 and the bottom surface 4b, a second wavelength selective filter 62 is disposed between the second semiconductor laser 32 and the bottom surface 4b, a third wavelength selective filter 63 is disposed between the third semiconductor laser 33 and the bottom surface 4b and a reflection mirror 64 is disposed between the fourth semiconductor laser 34 and the bottom surface 4b.

The reflection mirror 64 reflects the fourth optical signal emitted from the fourth semiconductor laser 34 to make it enter the third wavelength selective filter 63. The third wavelength selective filter 63 reflects the third optical signal emitted from the third semiconductor laser 33 to make it enter the second wavelength selective filter 62, and passes the fourth optical signal to make it enter the second wavelength selective filter 62. The second wavelength selective filter 62 reflects the second optical signal emitted from the second semiconductor laser 32 to make it enter the first wavelength selective filter 61, and passes the third and fourth optical signals to make them enter the first wavelength selective filter 61. The first wavelength selective filter 61 reflects the first optical signal emitted from the first semiconductor laser 31, and passes the second optical signal, the third optical signal, and the fourth optical signal. More specifically, from the first wavelength selective filter 61, a multiplexed optical signal obtained by the wavelength division multiplexing of the first optical signal, the second optical signal, the third optical signal and the fourth optical signal is emitted.

As described above, in this embodiment, both of the semiconductor lasers 30 and the driver ICs 40 are mounted on the same substrate 20. Therefore, the transmission distance of digital signals between the semiconductor lasers 30 and the driver ICs 40 is shortened compared with the prior art, and the degradation of the digital signals is suppressed. Furthermore, since the semiconductor lasers 30 and the driver ICs 40 are disposed in a row, the transmission distance of the digital signals is shortened compared with the case where they are disposed in a plurality of rows.

Note that, with the increase of the communication speed, the driving speed of the light emitting element is also increased, with the result that the heat generation from the light emitting element and the driving element is increased. Therefore, it is preferable to consider the improvement in the heat dissipation efficiency of the light emitting element and the driving element in addition to the shortening of the transmission distance between the light emitting element and the driving element. In this respect, in the present embodiment, the driving element (driver IC 40) and the chassis 4 are thermally connected through the heat dissipation sheet 50. Therefore, the heat of the driver IC 40 is efficiently dissipated. Furthermore, the heat of the light emitting element (semiconductor laser 30) mounted on the same substrate 20 as the driver IC 40 is also efficiently dissipated through the substrate 20 and the driver IC 40.

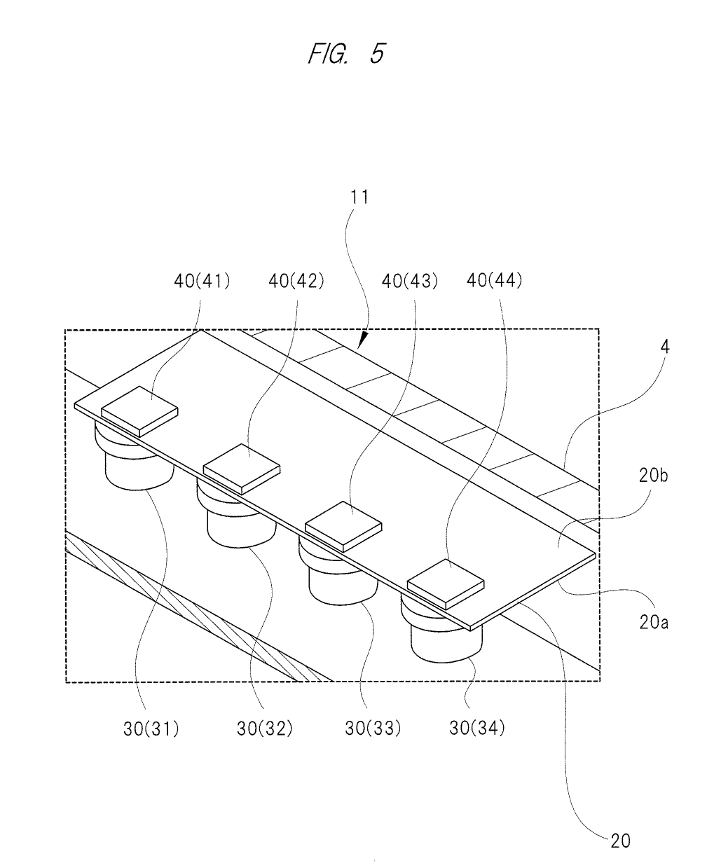

The present invention is not limited to the foregoing embodiment and various modifications and alterations can be made within the scope of the present invention. For example, as shown in FIG. 5, the semiconductor lasers 30 may be surface-mounted on the first surface 20a of the substrate 20. In this case, the lead pins 35 (FIG. 3) of the semiconductor lasers 30 do not protrude from the second surface 20b of the substrate 20. Therefore, the driver IC 40 can be disposed on the second surface 20b of the substrate 20 and just above the semiconductor laser 30. More specifically, the driver IC 40 and the semiconductor laser 30 can be disposed at positions opposed to each other with the substrate 20 interposed therebetween. As a result, the size of the substrate 20 in the width direction can be reduced, and the size of the chassis 4 housing the substrate 20 in the same direction can also be reduced.

What is claimed is:

1. An optical communication module which outputs a multiplexed optical signal, comprising:
a plurality of light emitting elements which emit optical signals each having different wavelengths;
a plurality of driving elements which drive each of the plurality of light emitting elements; and
a substrate on which both of the light emitting elements and the driving elements are mounted,
wherein the light emitting elements are mounted on a first surface of the substrate, and
the driving elements are mounted on a second surface of the substrate opposite to the first surface.

2. The optical communication module according to claim 1, further comprising:
a chassis in which the substrate is housed,
wherein a surface of the driving element and a first inner surface of the chassis are thermally connected through a heat conducting member.

3. The optical communication module according to claim 2,
wherein the plurality of light emitting elements are disposed in a row along a longitudinal direction of the chassis, and
each of the light emitting elements emits an optical signal to a second inner surface of the chassis opposed to the first inner surface.

4. The optical communication module according to claim 1,
wherein the plurality of light emitting elements are surface-mounted on the first surface of the substrate, and
the respective driving elements are mounted at positions opposed to the light emitting elements serving as objects to be driven with interposing the substrate therebetween.
